(19) United States
(12) Patent Application Publication
(10) Pub. No.: US 2015/0031786 A1
(43) Pub. Date: Jan. 29, 2015

(54) Process for Producing a Powder Comprising an Extruded Carrier With an Active Compound

(71) Applicant: ALBEMARLE CORPORATION, Baton Rouge, LA (US)

(72) Inventor: Gregory H. Lambeth, Baton Rouge, LA (US)

(21) Appl. No.: 14/376,796

(22) PCT Filed: Feb. 14, 2013
(86) PCT No.: PCT/US2013/026189

§ 371 Date: Aug. 5, 2014

Related U.S. Application Data
(60) Provisional application No. 61/598,472, filed on Feb. 14, 2012.

(51) Int. Cl. C05G 3/00; C05G 3/08

(52) U.S. Cl. CPC C05G 3/0058; C05G 3/08
USPC 523/132

(57) ABSTRACT

This invention provides processes for forming powders comprising at least one active compound and at least one carrier. The processes comprise (i) heating at least one active compound to at least its melting point or softening point; and (ii) in an extruder, combining at least the at least one active compound with at least one carrier, to form combined ingredients, and cooling the combined ingredients as they pass through the extruder, such that the combined ingredients exit the extruder at about ambient temperature in the form of a powder having particles sized so that about 95 wt % or more of the powder passes through a screen of about 8 standard U.S. mesh.

### TECHNICAL FIELD

This invention relates to processes for producing a powder comprising at least one carrier, such as a urea-formaldehyde polymer, and at least one active compound, such as N-(n-butyl)thiophosphoric triamide.

### BACKGROUND

Nitrogen is an important nutrient for plant growth and development, so nitrogen fertilizers are commonly and frequently used in agriculture. Granular urea, CO(NH₂)₂, has been heavily used in the agricultural industry as a nitrogen fertilizer. Urease, an enzyme found in numerous fungi and bacteria, hydrolyzes urea to form ammonia and carbon dioxide. Rapid hydrolysis of ammonia produces ammonium ions, which are then converted into nitrates through bacterial oxidation, a process also known as nitrification. Plants can use nitrogen from either (i) urea via urease-catalyzed hydrolysis, or (ii) the nitrates derived from bacterial oxidation of the ammonium ions. The ammonium ion and nitrate production from these processes typically occur within 2 to 20 days from application of a nitrogen fertilizer, while crops typically grow from 50 to 200 days. The nitrogen sources are typically lost prematurely, before growing crops can utilize them fully Ammonium is typically vaporized into the atmosphere, and nitrates are leached into the subsoil or lost due to bacterial denitrification, i.e., conversion of nitrate into elemental nitrogen. In addition, ammonia formed by urea hydrolysis may accumulate and damage germinating seedlings and young plants. There have been several approaches in the industry to address these issues.

One approach focuses on frequent fertilizer applications throughout the crop growth season. However, multiple applications of fertilizers result in increased cost due to use of additional fertilizer material, application costs, and additional time. Multiple applications of fertilizer also result in adverse environmental impact due to loss of nitrates through their leaching into the subsoil.

Another approach employs controlled release fertilizers. In this approach, substances such as sulfur are applied to the fertilizer pellet. The fertilizer pellet is then further coated with a material impervious to water, e.g., an oily substance, to allow suitable rates of dissolution of the nitrogen fertilizer. However, sulfur-coated urea tends to be expensive, while also resulting in lower nitrogen production as compared to uncoated granular urea.

In yet another approach, usable plant nitrogen sources from urea can be improved by incorporating a urease inhibitor or a nitrification inhibitor into the granular urea. Phosphoric triamides are known urease inhibitors. In particular, N-(n-butyl)thiophosphoric triamide (NBPT) has been shown to reduce the production of ammonia in the soil caused by urea hydrolysis. Delaying urea hydrolysis results in (i) longer availability of usable nitrogen sources for plants; (ii) decreased amounts of ammonia; (iii) reduced seedling and young plant damage from high levels of ammonia; (iv) reduced loss of nitrogen from ammonium ion volatilization; (v) increased nitrogen uptake by plants; and (vi) increased crop yield.

The industrial applicability of urea-formaldehyde polymers has been known for some time. These polymers find use in diverse applications, including as an additive in paper, paint, and varnish applications, and in the agricultural industry. In agricultural applications, urea-formaldehyde polymers serve mainly as a carrier for an active ingredient.

NBPT, as noted, is a urease inhibitor. NBPT is a waxy, sticky, heat-sensitive and water-sensitive material. Often, NBPT, the active ingredient, is deposited into the cavities and onto the surface of a urea-formaldehyde polymer by dissolving the NBPT in a solvent, and spraying this solution onto the surface of a urea-formaldehyde polymer, usually in a fluidized bed drier. The solvent is then removed via volatilization using hot air in the fluidized bed dryer, producing a urea-formaldehyde polymer coated with the active ingredient.

However, it has been discovered that some solvents presently used in Fluidized bed spraying processes do not completely volatize. Incomplete volatilization of the solvent limits the amount of active ingredient deposited onto the urea-formaldehyde polymer carrier. Because many active ingredients, such as NBPT, are heat-sensitive, long periods of heating to improve volatilization lead to increased thermal degradation of the active compounds. One alternative, heating in a lower pressure environment, creates a milder heating condition, but for longer periods of time, which also leads to degradation of the active compound. Further, fluidized bed driers are specialized pieces of equipment requiring extensive and expensive air handling and conditioning capabilities.

In addition to the degradation issues associated with incorporating certain active compounds onto urea-formaldehyde polymers, the product ideally should have particle sizes suitable for the intended application. For example, products that are in the form of a powder are desired.

Therefore, there is a need in the art for an improved process whereby urea-formaldehyde polymers can be effectively used as carriers for active ingredients, especially thermally-sensitive active ingredients. There is also a need for processes that reduce thermal degradation of active compounds when combining them with carriers, such as urea-formaldehyde polymers.

### SUMMARY OF THE INVENTION

This invention provides a process for producing a powder from a carrier and at least one active compound. The process has many advantages, including obtainment of desired particle sizes as the product exits the extruder, which in turn means that no further processing of the powders is needed; no heating is required during the extrusion process, which for thermally-sensitive compounds, minimizes or eliminates degradation during processing. A further advantage of the processes of this invention is that no solvent is necessary.

One embodiment of this invention is a process for forming powders comprising at least one active compound and at least one carrier. The process comprises
(i) heating at least one active compound to at least its melting point or softening point; and
(ii) in an extruder, combining at least the at least one active compound with at least one carrier, to form combined ingredients, and cooling the combined ingredients as they pass through the extruder, such that the combined ingredients exit the extruder at about ambient temperature in the form of a powder having particles sized so that about 95 wt % or more of the powder passes through a screen of about 8 standard U.S. mesh.

Another embodiment of this invention is a process for forming powders comprising N-(n-butyl)thiophosphoric triamide and at least one urea-formaldehyde powder. The process comprises
(i) heating N-(n-butyl)thiophosphoric triamide to at least its melting point or softening point; and
(ii) in an extruder, deaerating at least one solid urea-formaldehyde polymer, combining the N-(n-butyl)thiophosphoric triamide with the deaerated urea-formaldehyde polymer to form combined ingredients, and cooling the combined ingredients as they pass through the extruder such that the combined ingredients exit the extruder at about ambient temperature in the form of a powder.

These and other embodiments and features of this invention will be still further apparent from the ensuing description, drawing, and appended claims.

### BRIEF DESCRIPTION OF THE DRAWING

FIG. 1 is a diagram representing the zones of an extruder and the screw segments of an extruder screw used to form preferred powders of the invention.

### FURTHER DETAILED DESCRIPTION OF THE INVENTION

The powders produced by the processes of this invention are generally flowable, and have greater amounts of the active compound on the carriers than would typically be achieved by spraying the active compound onto a carrier. Without wishing to be bound by theory, it is believed that the processes of this invention provide powders in which the carriers have a more uniform coating of the active compound.

In some embodiments of the invention, a large majority of the powder formed, typically about 95 wt % or more, passes through a screen of about 8 standard U.S. mesh (2.38 mm) Preferably, about 95 wt % of the powders formed by the processes of this invention pass through a screen of about 10 standard U.S. mesh (2.0 mm) More preferably, the powders formed in this invention pass through a screen of about 12 standard U.S. mesh (1.68 mm) Another way of expressing this is, for example, as a powder sized so that less than 3 wt % of over-sized particles are retained on a 12 or lower mesh screen.

In preferred embodiments, this invention provides a process for producing an active urea-formaldehyde compound (AUFC). The acronym “AUFC” as used herein means a compound that comprises at least one urea-formaldehyde polymer and at least one active compound. In particular, preferred processes of this invention produce a product having (i) greater amounts of active compound present in the AUFC than were previously achievable; (ii) more uniform distribution of the active compound on the urea-formaldehyde polymer; and/or (iii) a more desirable particle size, e.g., such that about 95 wt % or more of the powder passes through a screen of about 8 standard U.S. mesh. Preferably, about 95 wt % of the powder passes through a screen of about 10 standard U.S. mesh. More preferably, about 97 wt % of the AUFC powder passes through a screen of about 12 standard U.S. mesh.

In a preferred aspect of the invention, a process is provided for producing an AUFC comprising heating at least one active compound to at least its melting point or softening point; combining the active compound with at least one solid urea-formaldehyde polymer to form combined ingredients; and cooling the combined ingredients to about ambient temperature to transform the combined ingredients into a powder AUFC. When the active compound is thermally-sensitive, the heating is preferably such that decomposition of the active compound is minimized or avoided, and the heating is normally enough to melt or soften the active compound. For compounds that are not thermally-sensitive, the heating can be to one or more temperatures above their melting or softening points. For example, if an active compound has a melting point of 150° F., it can be heated to about 150° F. or higher.

While not wishing to be bound by theory, it is believed that the particle size of the AUFC powders can be improved by (i) thoroughly mixing the urea-formaldehyde polymer and the active compound, and (ii) controlling the heating and cooling of the combined urea-formaldehyde polymer and active compound. It is also theorized that improving both the mixing and the control of cooling of the combined urea-formaldehyde polymer and active compound can increase the effective amount of the active compound incorporated into the AUFC. At least for thermally-sensitive active compounds, it is known that the longer the time of heating and the higher the temperature at which the active compound is heated, the greater the extent of degradation of the active compound, resulting in an AUFC with an effectively lower amount of the active compound. As such, in preferred embodiments, an extruder is configured to provide controlled cooling, better mixing, and breaking agglomerates into smaller-sized particles. It is believed that the high surface area to volume ratio provided by an extruder allows for controlled rates of heating and cooling, and more thorough mixing.

Active compounds suitable in the practice of this invention include urease inhibitors, nitrification inhibitors, fungicides and insecticides. Two or more different active compounds can be used if desired.

The active compound may be in the form a liquid, supercooled liquid, a solution dissolved or partially dissolved in a non-volatile solvent, a solution dissolved or partially dissolved in a volatile solvent, a solid, a partially melted solid, and combinations thereof. In one preferred embodiment, the active compound is in liquid form. Solid active compounds are preferably fed into the extruder in liquid form, more preferably, liquid form is obtained by melting or softening the solid active compound.

In some preferred embodiments, the active compound is selected from any compound commonly incorporated with or onto urea-formaldehyde polymers, for example, nitrification inhibitors and urease inhibitors. Nitrification inhibitors include dicyanodiamide (dicyandiamide or DCD). As used throughout this document, the phrase “urease inhibitor” refers to compounds that interfere with urease activity and reduce urea hydrolysis. Non-limiting examples of urease inhibitors include compounds of the formula:

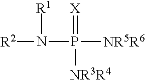

wherein X is sulfur or oxygen; R¹ and R² are each, independently, hydrogen, alkyl, alkenyl, alkynyl, cycloalkyl, aralkyl or cycloalkenyl; or R¹ and R² together form an alkylene or alkenylene chain, optionally containing one or more heteroatoms of oxygen, sulfur or nitrogen, completing a 3-, 4-, 5, 6-, 7- or 8-membered ring system; and R³, R⁴, R⁵ and R⁶ are the same or different and are individually hydrogen or alkyl having from 1 to about 4 carbon atoms.

In the above formula, R¹ and R² can be methyl, ethyl, propyl, isopropyl, n-butyl, isobutyl, sec-butyl, tert-butyl, pentyl, isopentyl, neopentyl, tert-pentyl, hexyl, 2-methylpentyl, heptyl, octyl, 2-ethylhexyl, isooctyl, nonyl, isononyl, decyl or isodecyl; cyclopropyl, cyclobutyl, cyclopentyl, cyclohexyl, or cyclooctyl; phenyl, xylyl, or naphthyl. When R¹ and R² together complete a ring system, R¹R² can be ethylenyl, propylenyl, butylenyl, pentylenyl, hexylenyl, hex-3-enylenyl, heptylenyl, or octylenyl. Preferably, one of R¹ and R² is hydrogen and the other is n-propyl, n-butyl, isobutyl, pentyl, or cyclohexyl.

Suitable urease inhibitors of the above formula include N-(n-propyl)thiophosphoric acid triamide and N-(n-butyl)thiophosphoric triamide. In a preferred embodiment, the active compound is N-(n-butyl)thiophosphoric triamide (“NBPT”).

A variety of substances are suitable carriers in the practice of this invention, provided that the substance remains in solid form, i.e., a suitable carrier does not melt in the extruder. The carriers generally have a high surface area, typically about 0.5 m²/g or more. Suitable carriers include, but are not limited to, urea-formaldehyde polymers (also referred to as polymethyl ureas), thermoplastic polymers, inorganic oxides such as precipitated silicon dioxide, granulated starch, and microcrystalline cellulose. Preferred carriers in the practice of this invention are urea-formaldehyde polymers. Urea-formaldehyde polymers (“UFP”) suitable for use herein are solid urea-formaldehyde polymers. Preferred solid urea-formaldehyde polymers have thermoset properties. Mixtures of two or more urea-formaldehyde polymers can be used, provided that the mixture is a solid.

These urea-formaldehyde polymers can be made by any method known in the art. For example, urea-formaldehyde polymers that can be used herein can be made by the process taught in U.S. Pat. No. 4,101,521. At least some urea-formaldehyde polymers are also commercially available. Urea-formaldehyde polymers suitable for use in this invention that are commercially available include those sold under the name PERGOPAK® by Albemarle Corporation, preferably the PERGOPAK® M line of urea-formaldehyde polymers; the PERGOPAK® M urea-formaldehyde polymers are preferred urea-formaldehyde polymers

In one embodiment of the present invention, the urea-formaldehyde polymer is selected from those having a water content of about 1 to about 80 wt % of the weight of the urea-formaldehyde polymer. In another embodiment, the urea-formaldehyde polymer is selected from those having a water content of about 10 to about 35 wt % of the weight of the urea-formaldehyde polymer. In yet another embodiment, the urea-formaldehyde polymer is selected from those having a water content of about 10 to about 20 wt % of the weight of the urea-formaldehyde polymer.

In some embodiments, the active compound is preferably employed in amounts of about 35 wt % or more relative to the total weight of the carrier and the active compound; more preferably about 40 wt % or more, and still more preferably about 45 wt % or more, relative to the total weight of the carrier and the active compound. In other words, powder produced by the processes of this invention preferably comprise about 35 wt % or more of the active compound; more preferably about 40 wt % or more; and still more preferably about 45 wt % or more relative to the total weight of the carrier and the active compound.

In some preferred embodiments, the active compound is preferably employed in amounts of about 50 wt % or more relative to the total weight of the carrier and the active compound; more preferably, about 60 wt % or more; still more preferably about 65 wt % or more; and even more preferably about 70 wt % or more, relative to the total weight of the carrier and the active compound. In other words, powder produced by the processes of this invention preferably comprise about 50 wt % or more of the active compound; more preferably about 60 wt % or more; and still more preferably about 70 wt % or more relative to the total weight of the carrier and the active compound.

In addition to the active compound(s) and the carrier, one or more other additives may be included. Other additives include dust inhibitors, such as mineral oil; odor masking agents, such as fragrances; flow improvers, such as fumed silica gel; wettability improvers, such as surfactants; coloring agents, such as dyes or pigments; and stabilizers. Stabilizers are a preferred type of optional additive. Suitable stabilizers are different for different active compounds.

When a stabilizer is included, it is generally about 1 part per 100 parts of active compound. Having about 5 parts or more of stabilizer per 100 parts of active compound usually produces beneficial effects. Preferably, there are about 5 parts to about 30 parts of stabilizer per 100 parts of active compound; more preferably, there are about 10 parts or more of stabilizer per 100 parts of active compound; still more preferably, there are about 10 parts to about 25 parts of stabilizer per 100 parts of active compound.

In some preferred embodiments, a stabilizer is included in the combined ingredients. Stabilizers that appear to be effective for NBPT are compounds that have at least one hydroxyl group, and include alcohols, including ethanol, isopropanol, n-butanol, and the like; polyalcohols, including ethylene glycol and propylene glycol, and amine alcohols, including triethanolamine. Two or more stabilizers can be used if desired.

Although use of a solvent is not necessary, one or more solvents may be employed in admixture with the active compound and/or one or more optional additives; such solvent is usually removed during the extrusion process.

In the processes of this invention, the ingredients are combined in an extruder. Suitable types of extruders include single screw extruders and twin-screw extruders. Both co-rotating and counter-rotating twin-screw extruders can be used in the practice of this invention.

Extruders are typically comprised of a screw or screws and a housing comprising one or more feeders, as needed, and one or more injection ports, as needed.

The housing may be of any shape, size, and material suitable for containing and/or providing any of the functions of holding, moving, heating, cooling, processing, mixing, chopping, grinding, kneading, heating, sizing, and/or separating, on the active compound, the carrier, optional additives, if any, and/or the combined ingredients. If there is more than one housing, the housings may be configured in any spatial arrangement.

In one embodiment, at least as portion of the housing of the extruder is configured to cool the combined ingredients of active compound and the carrier in at least one cooling zone or section. As used herein, “cooling zone” and “cooling section” are synonymous and refer to one or more areas where cooling of the active compound, carrier, optional additives, and/or combined ingredients occurs.

A non-limiting example of a housing is a barrel suitable for the extrusion process. The barrel may be constructed in any manner known in the art suitable for receiving and/or cooling the active compound, carrier, optional additives, and/or the combined ingredients. The at least one barrel is sized and configured to receive and/or cool the active compound, carrier, optional additives, and/or the combined ingredients. The barrel may use any means known in the industry for cooling; non-limiting examples of cooling means include chilled water or glycol pumped into the barrel, heat exchangers, screw cooling, vent valves, and the like. When there is more than one barrel, each barrel may be cooled to one or more temperatures independently of the other.

In the extruder, the housing or barrel is configured and sized to contain, and does contain, at least one extrusion screw. Extrusion screws suitable for the present invention may be configured and sized to any shape and length and adjusted to any throughput rate that allows sufficient mixing and/or cooling of the carrier and the active compound so that a powder having the desired particle size is formed. The extruder screw or screws are sized and configured to deaerate, compress, knead, chop, grind, mix, and/or cool the active compound, carrier, and/or combined ingredients to form a powder having the desired particle size, preferably so that about 95 wt % or more of the powder passes through a screen of about 8 standard U.S. mesh; more preferably, about 95 wt % of the powder passes through a screen of about 10 standard U.S. mesh; still more preferably, about 97 wt % or more of the powder passes through a screen of about 12 standard U.S. mesh, especially when the carrier is a urea-formaldehyde polymer. The screw or screws of the extruder achieve these actions by having different screw elements (or screw segments) arranged in series along the screw shaft. For example, an extruder screw can have one or more conveying elements, kneading blocks, mixing elements, and so forth, as needed.

In the practice of this invention, the extruder screw is configured to mix the active compound and the carrier, preferably to make the combined ingredients homogenous; to break up agglomerates, preferably to the desired particle size; for forward and reverse conveying of the carrier, active compound, and/or combined ingredients. In another embodiment, the extruder screw or screws are configured to improve the cooling rate of the active compound and the carrier by increasing contact with the barrel of the extruder, wherein the extruder screw or screws are internally cooled. In yet another embodiment, the extruder screw is configured with the drive torque to sufficiently transform the carrier and active compound into a powder having the desired particle size. In another embodiment, the extruder screw is sized and configured to reduce agglomeration of the combined ingredients. In another embodiment the extruder screw or screws are sized and configured to increase the amount of active compound in the powder.

In the processes of this invention, combining at least one active compound and at least one carrier in an extruder forms combined ingredients. The extruder housing or barrel where the combining occurs and in which the combined ingredients exists may be referred to as the mixing zone or mixing section. The terms “mixing section” and “mixing zone” are synonymous and indicate one or more areas in the extruder where the primary function is to mix the active compound(s) and the carrier. The mixing zone is not intended to limit the housing only to mixing functions; there may be other functions also occurring within the housing. The mixing zone may span one or more housing(s). The active compound(s) and any optional additives may be dispensed in any manner in any part of the mixing zone. Adequate mixing of the active compound and carrier results in a powder with a greater amount of active compound on the carrier, and/or more desirable particle sizes.

At least when the carrier is a urea-formaldehyde polymer, the carrier is deaerated prior to combining it with the active compound(s). Any technique available in the art may be used to deaerate the carrier. The carrier, especially a urea-formaldehyde polymer, may be deaerated prior to contacting it with the active compound. Conveniently and preferably, deaeration can be performed in an extruder; more preferably, deaeration of the carrier is performed in the same extruder as the combining with the active compound(s) by using an appropriate screw element prior to the point or points at which the active compound(s) is introduced.

In the processes of this invention, the carrier or carriers are introduced into the extruder via one or more feeders; in other words, the carrier(s), may be added in a single batch or separated into two or more batches. Each batch may be a homogenous or heterogeneous mixture, at least when the carrier is a urea-formaldehyde polymer. When introduced in two or more batches, the carrier, especially a urea-formaldehyde polymer, may be of any relative amount in each batch. For example, a first batch can comprise in the range of about 1 wt % to about 99 wt % of the carrier, and a second batch comprises in the range of about 99 wt % to about 1 wt % of the carrier. In yet a further embodiment, the first batch comprises in the range of about 30 wt % to about 70 wt % and the second batch comprises in the range of about 70 wt % to about 30 wt % of the carrier.

When a solid active compound is introduced to the extruder in liquid form, it is heated to its melting or softening point. The term “softening point” is used in this document to recognize that some substances do not have a clearly-defined melting point. The active compound(s) may be heated prior, during, or after separation into batches. The active compound may be housed by any means capable of heating the active compound to at least its melting or softening point. Melted or softened active compound(s) are introduced into the extruder via an injection port, pumps, manual feeding, or any other means known in the art. The injection port or ports through which melted or softened active compound(s) are introduced may be heated to prevent freezing of the active compound in the injection port. In the processes of this invention, heat is used to melt or soften the active compound(s) and to prevent freezing in the injection port. No heat is added on the extrusion line.

The active compound(s) may be a single batch or separated into two or more batches, which may be of any relative amount. When two or more active compounds are used, each batch may be a homogenous or heterogeneous mixture of the active compounds. When introduced in two or more batches, the active compound may be of any relative amount in each batch. For example, a first batch can comprise in the range of about 1 wt % to about 99 wt % of the active compound, and a second batch comprises in the range of about 99 wt % to about 1 wt % of the active compound. In yet a further embodiment, the first batch comprises in the range of about 30 wt % to about 70 wt % of the active compound and the second batch comprises in the range of about 70 wt % to about 30 wt % of the active compound.

When optional additives are included, liquid optional additives can be premixed with the melted or softened active compound(s), or introduced via a one or more separate injection ports. Solid optional additives can be premixed with the carrier, or introduced via one or more feeders on the extruder. When more than one optional additive is included, they may be added separately or in any combination.

The active compound may be contacted with the carrier in any combination, non-limiting examples include a single batch of active compound to be contacted with a single carrier batch to be mixed; at least two active compound batches may be contacted with a single carrier batch to be mixed; a single active compound batch may be contacted with at least two carrier batches to be mixed; at least two active compound batches maybe contacted with at least two carrier batches to be mixed. Where there are two or more batches comprising at least one active compound and at least one carrier, the batches may be contacted together and further mixed. If there are two or more active compound batches, the batches may be dispensed simultaneously or separately, e.g., staggered or alternating, in any manner to be combined with the carrier. In another aspect of this preferred embodiment, an injection port is configured to dispense, inject, or pump at least one active compound at its melting point onto the carrier in the extruder. At least when the carrier a urea-formaldehyde polymer, the carrier may be deaerated. Preferably, the carrier, especially a urea-formaldehyde polymer, is compressed and deaerated.

In some embodiments, an injection port is used to introduce the active compound into the extruder. Preferred temperatures may depend on the melting point of the active compound.

When the active compound is NBPT, the injection port is preferably heated to a temperature of about 100° F. or higher; more preferably, about 120° F. or higher; still more preferably, about 140° F. or higher. In some instances, it is preferable to heat the injection port to a temperature of about 150° F. or higher.

In some embodiments, at least one barrel is cooled to temperature of about 60° F. or below; preferably about 40° F. or below; more preferably about 20° F. or below. The thermal sensitivity, if any, of the active compound affects the preferable temperatures for cooling of the barrels. In some instances, rapid cooling and sufficient mixing of the active compound and carrier after combining correlates with a solid powder having (i) more desirable particle sizes and/or (ii) a greater amount of active compound on the carrier.

In some preferred embodiments, especially when the active compound is N-(n-butyl)thiophosphoric triamide, the injection port is heated and the extruder barrels are cooled. Preferred temperatures for such heating of the injection port and cooling of the extruder barrels are as described above.

In the processes of this invention, the active compound, the carrier, optional additives, and/or the combined ingredients are cooled to one or more temperatures to transform them into a powder having the desired particle size. The cooling is sufficient to remove both latent heat and heat of crystallization of the substances added (the active compound, carrier, and/or optional additives).

Cooling of the ingredients and the combined ingredients formed therefrom occurs as they travel down the screw or screws from their point(s) of introduction until the combined ingredients exit the extruder. In the practice of this invention, the highest temperatures are at the introduction of the active compound(s), and the temperature decreases as the material travels down the screw(s). The heat removed by the cooling often includes heat of crystallization as well as latent heat. The combined ingredients are normally and preferably cooled so that the combined ingredients reach ambient temperature as it exits the extruder, forming a powder. The powders tend to re-agglomerate if they are still warm when they exit the extruder. In preferred embodiments, the active compound is NBPT, and the exit temperature is below about 100° F., more preferably below about 90° F., and still more preferably below about 80° F.

In the practice of this invention, the spatial arrangement, shape, size, and number of housings and extrusion screws; temperatures; and/or throughput rates, can be configured and/or adjusted in any manner suitable to produce a powder product having the desired (i) amount of active compound present on the carrier, (ii) homogenous mixture of the active compound and the carrier, and/or (iii) particle sizes.

The processes of this invention produce powders having particles sized so that about 95 wt % or more of the powder passes through a screen of about 8 standard U.S. mesh (2.38 mm) Preferably, the powder has particles sized so that about 97.0 wt % or more of the powder passes through a screen of about 8 standard U.S. mesh. More preferably, the powder has particles sized so that about 98.0 wt.% or more of the powder passes through a screen of about 8 standard U.S. mesh; still more preferably, the powder has particles sized so that about 99.0 wt.% or more of the powder passes through a screen of about 8 standard U.S. mesh. Even more preferably, the powder has particles sized so that about 99.5 wt.% or more of the powder passes through a screen of about 8 standard U.S. mesh.

In another embodiment, the powder has particles sized so that about 95 wt % or more of the powder passes through a screen of about 10 standard U.S. mesh (2.0 mm) Preferably, the powder has particles sized so that about 97.0 wt % or more of the powder passes through a screen of about 10 standard U.S. mesh. More preferably, the powder has particles sized so that about 98.0 wt.% or more of the powder passes through a screen of about 10 standard U.S. mesh; still more preferably, the powder has particles sized so that about 99.0 wt.% or more of the powder passes through a screen of about 10 standard U.S. mesh. Even more preferably, the powder has particles sized so that about 99.5 wt.% or more of the powder passes through a screen of about 10 standard U.S. mesh.

In still another embodiment, about 97 wt % or more of the powder passes through a screen of about 12 standard U.S. mesh (1.68 mm; also expressed as sized below 3 wt.% for over-sized particles on a 12 mesh screen). Preferably, the powder has particles sized so that about 98 wt % or more of the powder passes through a screen of about 12 standard U.S. mesh; more preferably, the powder has particles sized so that about 99 wt % or more of the powder passes through a screen of about 12 standard U.S. mesh. Still more preferably, the powder has particles sized so that about 99.5 wt % of the powder passes through a screen of about 12 standard U.S. mesh. These preferences for passing through a 12-mesh screen apply at least to powders of NBPT on a urea-formaldehyde polymer.

The provision of powders having the desired particle sizes is advantageous because certain active compounds, such as N-(n-butyl)thiophosphoric triamide, experience degradation when undergoing grinding or milling to form smaller particles.

This invention also provides powders comprising at least one active compound and at least one carrier, where the powder has particles sized so that about 95 wt % or more of the powder passes through a screen of about 8 standard U.S. mesh. Preferred are powders having particles sized so that about 97.0 wt % or more; more preferably about 98.0 wt % or more, still more preferably about 99.0 wt % or more; and even more preferably about 99.5 wt % or more, of the powder passes through a screen of about 8 standard U.S. mesh. Preferably, the particles are sized so that about 95 wt % or more of the powder passes through a screen of about 10 standard U.S. mesh; more preferably, about 97.0 wt % or more; still more preferably about 98.0 wt % or more, even more preferably about 99.0 wt % or more; and yet more preferably about 99.5 wt % or more, of the powder passes through a screen of about 10 standard U.S. mesh. More preferably, about 97 wt % or more of the powder passes through a screen of about 12 standard U.S. mesh. Still more preferably, about 98 wt % or more; even more preferably, about 99 wt % or more, of the powder passes through a screen of about 12 standard U.S. mesh.

In the powder, the active compound is preferably about 50 wt % or more, more preferably about 60 wt % or more, and still more preferably about 70 wt % or more, relative to the total weight of the carrier and the active compound. One or more optional ingredients as described above may be present in the powder. In preferred embodiments, the carrier is at least one urea-formaldehyde powder; in more preferred embodiments, the active compound is N-(n-butyl)thiophosphoric triamide, and the carrier is at least one urea-formaldehyde polymer.

The following examples are presented for purposes of illustration, and are not intended to impose limitations on the scope of this invention.

### EXAMPLES

Materials. In all of the Examples, the urea-formaldehyde polymer was PERGOPAK® M (Albemarle Corporation), a solid, powder urea-formaldehyde polymer with thermoset properties. The N-(n-butyl)thiophosphoric triamide (NBPT) was produced by Albemarle Corporation.

Equipment. The extruder in Examples 1-2 was a co-rotating twin-screw compounding extruder with open discharge (TEM 58 SS extruder, NFM/Welding Engineers, Inc., Massillon, Ohio). In Examples 1-2, the extruder barrels were made of wear resistant 10V alloy applied by HIP, and had a 40-horsepower AC motor and drive. The extruder was electrically heated, and water cooled. A chiller was hooked up directly to the barrels of the extruder to maximize cooling performance. There were 12 barrels (zones) along the length of the screws.

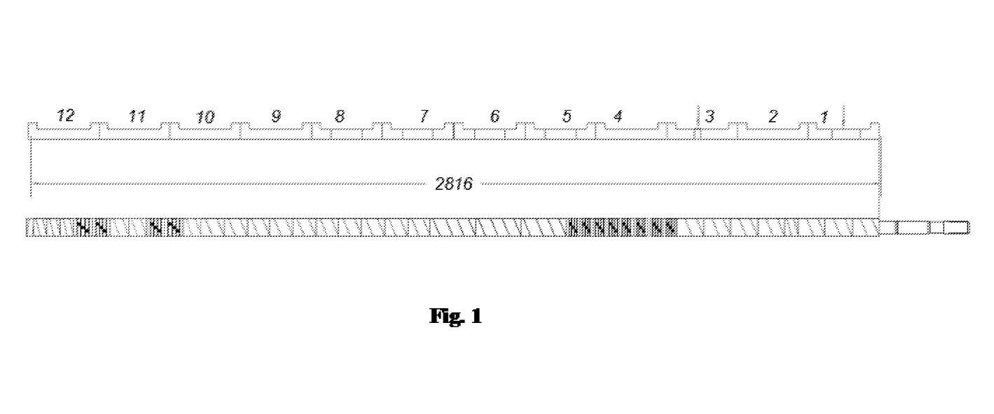

The extruder screws in Examples 1-2 were 58 mm in diameter, and had a 48:1 length to diameter ratio (L/D). The screws in Examples 1-2 were bimetallic 9V. The screws were operated as intermeshing screws. Different screw segments were assembled to form the desired screw functions. A diagram representing the 12 zones of the extruder and the screw segments in the sequence employed in both screws in Examples 1-2 is shown in FIG. 1. The downward arrow in zone 1 indicates that the urea-formaldehyde polymer was fed into Zone 1; similarly, the downward arrow in zone 3 indicates that the NBPT was fed into Zone 3. The material travelled along the screws from right to left as shown in FIG. 1.

As shown in the Figure, the screw has a variety of screw segments, which are represented by [symbol] for conveying elements and [symbol] for kneading blocks (elements). Table A below lists the particular arrangement of elements for the screw diagram shown in FIG. 1, in sequence from Zone 1 to Zone 12. In Table A, the number of segments means, for example, that there are 3 segments of that particular type before the next type of segment.

TABLE A

| Number of | Segment | Element | Element pitch | Segment |
|---|---|---|---|---|
| segments | type | length | or depth¹ | detail |
| 3 | Conveying | 90 mm | 90 mm | Deep flighted |
| 1 | Conveying | 45 mm | 45 mm | Transition |
| 4 | Conveying | 90 mm | 45 mm | Standard |
| 8 | Kneading | 45 mm | 5 mm | Forward |
| 3 | Conveying | 150 mm | 75 mm | Standard |
| 10 | Conveying | 75 mm | 75 mm | Standard |
| 1 | Conveying | 60 mm | 60 mm | Standard |
| 2 | Kneading | 60 mm | 5 mm | Forward |
| 2 | Conveying | 60 mm | 60 mm | Standard |
| 2 | Kneading | 60 mm | 5 mm | Standard |
| 1 | Conveying | 45 mm | 45 mm | Standard |
| 2 | Conveying | 45 mm | 45 mm | Slotted |
| 1 | Conveying | 22.5 mm | 22.5 mm | Reverse |

¹Pitch for conveying elements; depth for kneading elements.

Feeding of the urea-formaldehyde polymer powder was via a loss-in-weight solid feeder. In Examples 1-2, a K-Tron, Pitman, N.J., model no. K2MLT35QC loss-in-weight feeder was used. The feeder was connected to the first barrel of the extruder by a tube having a 2⅛ in. (5.4 cm) inner diameter and an open helix auger.

For melting the NBPT, a jacketed high intensity mixer (20 horsepower, 600-3000 rpm capacity, 13 in. (33 cm) diameter, 30-gallon (113.5 L) jacketed tank) was used in Examples 1-2. The mixer was connected to a feed tank, which feed tank was set up to meter a fluid into the extruder. The feed tank was a 2-gallon (7.6-liter) electrically heated tank for maintaining NBPT in the molten state for pumping to the extruder. In Examples 1-2, a progressive cavity pump (Duplex Piston Pump, Milton Roy Co., variable speed, variable stroke; 49 gal/hr (185.5 L/hr) per head capacity) metered the liquid feed into the extruder; the pump heads were jacketed for hot water circulation. A tempered hot water system was used to keep the mixer, feed line, pump, and injection valve warm enough to maintain NBPT in the molten state.

General Procedure. In Examples 1-2, the urea-formaldehyde polymer was fed via the loss-in-weight feeder into the first barrel of the extruder. The NBPT was melted in the mixer, fed to a tank where it was kept molten, and then fed from the tank into the extruder downstream of the urea-formaldehyde polymer. The combined ingredients were mixed and cooled as they traveled along the screws, and exited the extruder as a powder. Samples were collected from the powders exiting the extruder; the powders formed were collected in a fiber drum.

### Example 1

In this Example, the screw design shown in FIG. 1 as described above was employed. Urea-formaldehyde polymer powder and liquid NBPT were fed into the extruder. The molten NBPT was fed in one batch into Zone 3. The temperature on the NBPT injection port was set at 140° F. for start up, after which the injection port temperature was adjusted to 80° F. (26.7° C.). The product rate was raised from 300 lb/hr (136 k/hr) to 500 lb/hr (227 kg/hr) by adjusting both the urea-formaldehyde polymer and NBPT feed rates. An NBPT amount above 68 wt % could not be achieved at 500 lb/hr due to freezing in the NBPT injection port. Table 1 summarizes the process parameters for this Example. In all of the runs of this Example, a dry powder was discharged from the extruder. Product temperatures were slightly above 90° F. (32° C.). Samples were evaluated using 10- or 12-mesh (standard U.S.) sieve trays at the exit of the extruder to check for agglomerates. Results of some of the sieve tests are summarized in Table 3.

TABLE 1

| Sample | 1A | | 1B | | 1C | | 1D | |
|---|---|---|---|---|---|---|---|---|
| Total feed rate | 277 | lb/hr | 400 | lb/hr | 400 | lb/hr | 462 | lb/hr |
| | (125.6 | kg/hr) | (181.4 | kg/hr) | (181.4 | kg/hr) | (209.6 | kg/hr) |
| UFP feed rate | 120 | lb/hr | 120 | lb/hr | 120 | lb/hr | 150 | lb/hr |
| | (54.4 | kg/hr) | (54.4 | kg/hr) | (54.4 | kg/hr) | (68 | kg/hr) |
| NBPT feed rate | 157 | lb/hr | 280 | lb/hr | 280 | lb/hr | 312 | lb/hr |
| | (71.2 | kg/hr) | (127 | kg/hr) | (127 | kg/hr) | (141.5 | kg/hr) |
| Amount NBPT | 56.7 | wt % | 70 | wt % | 70 | wt % | 67.5 | wt % |
| Screw speed | 350 | rpm | 350 | rpm | 500 | rpm | 400 | rpm |
| Zone 2 | 147° | F. | 143° | F. | — | | 136° | F. |
| NBPT feed temp. | (63.9° | C.) | (61.7° | C.) | | | (57.8° | C.) |
| Zones 3-11 | 43-53° | F. | 44-60° | F. | 44-59° | F. | 46-59° | F. |
| mixing/cooling temp. | (6.1-11.7° | C.) | (6.7-15.6° | C.) | (6.7-15° | C.) | (7.8-15° | C.) |
| Product temp. | 90° | F. | 102° | F. | 104° | F. | 107° | F. |
| | (32° | C.) | (39° | C.) | (40° | C.) | (41.7° | C.) |

### Example 2

In this Example, the screw design shown in FIG. 1 as described above was employed. Urea-formaldehyde polymer powder and liquid NBPT were fed into the extruder. The molten NBPT was fed in one batch into Zone 3. The temperature on the NBPT injection port was set at 120° F. (49° C.). The product rate was raised from 300 lb/hr (136 kg/hr) to 500 lb/hr (227 kg/hr) by adjusting both the urea-formaldehyde polymer and NBPT feed rates. Table 2 summarizes the process parameters for this Example. In all of the runs of this Example, a dry powder was discharged from the extruder. Product temperatures were slightly above 90° F. (32° C.). Samples were evaluated using 10- or 12-mesh (standard U.S.) sieve trays at the exit of the extruder to check for agglomerates. Results of some of the sieve tests are summarized in Table 3.

TABLE 2

| Sample | 2A | | 2B | | 2C | | 2D | |
|---|---|---|---|---|---|---|---|---|
| Total feed rate | 300 | lb/hr | 300 | lb/hr | 350 | lb/hr | 350 | lb/hr |
| | (136 | kg/hr) | (136 | kg/hr) | (159 | kg/hr) | (159 | kg/hr) |
| UFP feed rate | 96 | lb/hr | 96 | lb/hr | 112 | lb/hr | 112 | lb/hr |
| | (43.5 | kg/hr) | (43.5 | kg/hr) | (50.8 | kg/hr) | (50.8 | kg/hr) |
| NBPT feed rate | 204 | lb/hr | 204 | lb/hr | 238 | lb/hr | 238 | lb/hr |
| | (92.5 | kg/hr) | (92.5 | kg/hr) | (108 | kg/hr) | (108 | kg/hr) |
| Amount NBPT | 68 | wt % | 68 | wt % | 68 | wt % | 68 | wt % |
| Screw speed | 250 | rpm | 250 | rpm | 500 | rpm | 450 | rpm |
| Zone 2 | 145° | F. | 114° | F. | 120° | F. | 120° | F. |
| NBPT feed temp. | (62.8° | C.) | (45.6° | C.) | (49° | C.) | (49° | C.) |
| Zones 3-11 | 43-55° | F. | 44-52° | F. | 46-55° | F. | 46-54° | F. |
| mixing/cooling temp. | (6.1-12.8° | C.) | (6.7-11.1° | C.) | (7.8-12.8° | C.) | (7.8-12.2° | C.) |
| Product temp. | 102° | F. | 99° | F. | 95° | F. | 90° | F. |
| | (39° | C.) | (37.2° | C.) | (35° | C.) | (32° | C.) |

TABLE 3

| | | | | | | Amount |
|---|---|---|---|---|---|---|
| Sam- | | Total feed | Amount | Screw | Screen | through |
| ple | Ex. ¹ | rate² | NBPT | speed | mesh³ | screen |
| E | 1B | 400 lb/hr | 70 wt % | 350 rpm | 12 | 98.86 wt % |
| F | 1C | 400 lb/hr | 70 wt % | 500 rpm | 12 | 99.74 wt % |
| G | 1C | 400 lb/hr | 70 wt % | 500 rpm | 10 | 99.06 wt % |
| H | ~1C | 400 lb/hr | 70 wt % | 450 rpm | 8 | 99.24 wt % |
| I | ~1C | 400 lb/hr | 70 wt % | 600 rpm | 10 | 99.77 wt % |
| J | ~1C | 400 lb/hr | 70 wt % | 600 rpm | 10 | 99.43 wt % |
| K | ~1C | 350 lb/hr | 68 wt % | 350 rpm | 8 | 99.5 wt % |
| L | 2C | 350 lb/hr | 68 wt % | 500 rpm | 10 | 99.52 wt % |
| M | 2A, 2B | 300 lb/hr | 68 wt % | 250 rpm | 8 | 98.33 wt % |
| N | ~2A-2B | 300 lb/hr | 68 wt % | 400 rpm | 8 | 99.61 wt % |
| P | ~2A-2B | 300 lb/hr | 68 wt % | 400 rpm | 10 | 98.87 wt % |
| Q | ~2A-2B | 300 lb/hr | 68 wt % | 400 rpm | 12 | 97.66 wt % |
| R | ~2A-2B | 300 lb/hr | 68 wt % | 500 rpm | 10 | 99.11 wt % |

¹ Here, “~” indicates that the conditions were similar to the Example run listed, but with a different screw speed.
²400 lb/hr = 181.4 kg/hr; 350 lb/hr = 159 kg/hr; 300 lb/hr = 136 kg/hr.
³Standard U.S. mesh; 12 mesh = 1.68 mm; 10 mesh = 2.0 mm; 8 mesh = 2.38 mm.

In Examples 3-5, a lab-scale counter-rotating, twin-screw extruder (Haake, model no. TW100) was employed.

### Example 3

The rotation speed for the screws was set at 110 rpm and the barrels of the extruder were maintained at 5° C. during the extrusion. N-(n-butyl)thiophosphoric triamide (NBPT, 460 g) was melted at 63° C. in a fully-jacketed addition funnel. This molten NBPT was added at 2.9 g/minute into the injection port of the extruder. Urea-formaldehyde polymer (Pergopak® M) was added into the same injection port through a single-screw powder feeder at 5.8 g/minute at the same time as the NBPT. After 2 hr and 40 minutes, 1.39 kg of powdery mixture was obtained. This powdery mixture was then added back into the powder feeder and fed at a rate of 4.8 g/minute into the injection port of the extruder while more molten NBPT was added at 5.5 g/minute into the injection port simultaneously; a white powder was obtained. The content of the NBPT in the final product was around 58.1 wt %, as determined by HPLC analysis. The material had 0.3 wt % agglomerates retained on a 12-mesh screen. In other words, 99.7 wt % of the final product passed through the 12-mesh screen.

### Example 4

The rotation speed for the screws was set at 110 rpm and the barrels of the extruder were maintained at 5° C. during the extrusion. A mixture of NBPT (90.9 wt %) and triethanolamine (9.1 wt %) was melted at 60° C. in a fully-jacketed addition funnel. This molten NBPT mixture was added at 3.3 g/minute into the injection port of the extruder. Urea-formaldehyde polymer (Pergopak® M) was added into the same injection port through a single-screw powder feeder at 3.3 to 5.0 g/minute at the same time as the NBPT mixture. After 2 hr and 40 minutes, 1.13 kg of powdery mixture was obtained. This powdery mixture was then added back into the powder feeder and fed at a rate of 3.3 g/minute into the injection port of the extruder while a mixture of molten NBPT (90.9 wt %) and triethanolamine (9.1 wt %) was added at 7.0 g/minute into the injection port simultaneously; a white powder was obtained. The content of the NBPT in the final product was around 61.3 wt %, as determined by HPLC analysis. The material had 0.5 wt % agglomerates retained on a 12-mesh screen.

### Example 5

The procedure of Example 2 was repeated, except that propylene glycol was used instead of triethanolamine. The final product contained 61.5 wt % NBPT as determined by HPLC analysis. The material had 0.1 wt % agglomerates retained on a 12-mesh screen.

### Example 6

Samples from Examples 1, 2 and 3 were subjected to an aging test. The samples were placed in closed glass containers and oven-aged at 40° C. for 3 months, and then analyzed by HPLC for the amount of NBPT present. Results are summarized in Table 4.

TABLE 4

| | | Initial NBPT | NBPT assay after | |
|---|---|---|---|---|
| Example | Additive¹ | assay | 3 months at 40° C. | Weight loss |
| 1 | None | 58.1 wt % | 38.1 wt % | 34% |
| 2 | TEA | 61.3 wt % | 53.7 wt % | 12% |
| 3 | PPG | 61.5 wt % | 49.8 wt % | 19% |

¹TEA = triethanolamine; PPG = propylene glycol.

The data in Table 4 show that the presence of 9.1 wt % propylene glycol decreases the loss of NBPT by more than 40%, and triethanolamine decreases the loss of NBPT by nearly two-thirds.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or ^{an} if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A process comprising:
(i) heating at least one active compound to at least its melting point or softening point; and
(ii) in a single screw extruder or a twin-screw extruder, combining at least the at least one active compound with at least one carrier, to form combined ingredients, and cooling the combined ingredients as they pass through the extruder, such that the combined ingredients exit the extruder at about ambient temperature in the form of a powder having particles sized so that about 95 wt % or more of the powder passes through a screen of about 8 standard U.S. mesh.

2. A process as in claim 1 wherein the active compound is selected from a group consisting of urease inhibitors, nitrification inhibitors, fungicides and insecticides.

3. A process as in claim 1 wherein the active compound is of the formula: 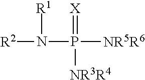
wherein
X is sulfur or oxygen;
R¹ is alkyl, alkenyl, alkynyl, cycloalkyl, aralkyl or cycloalkenyl,
R² is hydrogen, alkyl, alkenyl, alkynyl, cycloalkyl, aralkyl or cycloalkenyl,
or R¹ and R² together form an alkylene or alkenylene chain optionally containing one or more heteroatoms of oxygen, sulfur or nitrogen completing a 3-, 4-, 5-, 6-, 7- or 8-membered ring system; and
R³, R⁴, R⁵ and R⁶ are the same or different, and are individually hydrogen or alkyl having from 1 to about 4 carbon atoms.

4. A process as in claim 1 wherein the active compound comprises N-(n-butyl)thiophosphoric triamide.

5. A process as in claim 1 wherein the carrier is selected from urea-formaldehyde polymers, thermoplastic polymers, inorganic oxides, granulated starch, and microcrystalline cellulose.

6. A process as in claim 1 wherein the carrier is at least one urea-formaldehyde polymer, and wherein the urea-formaldehyde polymer is deaerated before the combining with at least the at least one active compound.

7. (canceled)

8. A process as in claim 1 further comprising deaerating the carrier before the combining with at least the at least one active compound.

9. A process as in claim 1 wherein the active compound is employed in an amount of about 35 wt % or more relative to the total weight of the carrier and the active compound.

10. A process as in claim 1 wherein at least one stabilizer is included in the combined ingredients.

11. A process as in claim 10 wherein the stabilizer is propylene glycol or triethanolamine, and/or wherein the stabilizer is in an amount of about 5 parts or more of stabilizer per 100 parts of active compound.

12. (canceled)

13. A process as in claim 1 wherein the powder has particles sized so that about 95 wt % or more of the powder passes through a screen of about 10 standard U.S. mesh.

14. (canceled)

15. A process comprising:
(i) heating N-(n-butyl)thiophosphoric triamide to at least its melting point or softening point; and
(ii) in a single screw extruder or a twin-screw extruder, deaerating at least one solid urea-formaldehyde polymer, combining the N-(n-butyl)thiophosphoric triamide with the deaerated urea-formaldehyde polymer to form combined ingredients, and cooling the combined ingredients as they pass through the extruder such that the combined ingredients exit the extruder at about ambient temperature in the form of a powder.

16. (canceled)

17. A process as in claim 15 wherein the active compound is employed in an amount of about 35 wt % or more relative to the total weight of the carrier and the active compound.

18. A process as in claim 15 wherein at least one stabilizer is included in the combined ingredients.

19. A process as in claim 18 wherein the stabilizer is propylene glycol or triethanolamine, and/or wherein the stabilizer is in an amount of about 5 parts or more of stabilizer per 100 parts of active compound.

20. (canceled)

21. A process as in claim 15 wherein the powder has particles sized so that about 95 wt % or more of the powder passes through a screen of about 8 standard U.S. mesh.

22. A process as in claim 15 wherein the powder has particles sized so that about 95 wt % or more of the powder passes through a screen of about 10 standard U.S. mesh.

23. (canceled)

24. A powder comprising at least one active compound and at least one carrier, where the powder has particles sized so that about 95 wt % or more of the powder passes through a screen of about 10 standard U.S. mesh.

25. A powder as in claim 24 wherein the carrier is at least one urea-formaldehyde polymer and/or wherein the active compound is N-(n-butyl)thiophosphoric triamide.

26. (canceled)

27. A powder as in claim 24 wherein the powder comprises about 35 wt % or more of the active compound relative to the total weight of the carrier and the active compound.

28. (canceled)

29. A powder as in claim 24 wherein the powder has particles sized so that about 97 wt % or more of the powder passes through a screen of about 12 standard U.S. mesh.
